(19) United States
(12) Patent Application Publication
(10) Pub. No.: US 2026/0166583 A1
(43) Pub. Date: Jun. 18, 2026

(54) COATING TREATMENT METHOD, STORAGE MEDIUM, AND COATING TREATMENT DEVICE

(71) Applicant: Tokyo Electron Limited, Tokyo (JP)

(72) Inventors: Toyohisa TSURUDA, Koshi City, Kumamoto (JP); Kazuhiro SHIBA, Koshi City, Kumamoto (JP); Naoto NAKAMURA, Koshi City, Kumamoto (JP)

(21) Appl. No.: 18/852,042

(22) PCT Filed: Mar. 17, 2023
(86) PCT No.: PCT/JP2023/010675

§ 371 Date: Sep. 27, 2024

(30) Foreign Application Priority Data
Mar. 30, 2022 (JP) 2022-055183

(51) Int. Cl. B05C 11/10; B05C 5/02

(52) U.S. Cl. CPC B05C 11/10; B05C 5/0225

(57) ABSTRACT

A coating treatment method includes individually acquiring surface images of a plurality of substrates having, on surfaces thereof, different coating films formed by supplying a processing liquid of different ejection amounts, acquiring a plurality of polar-coordinate-converted images by converting the surface images of the plurality of substrates into polar coordinates, respectively, displaying one or more polar-coordinate-converted images of the plurality of polar-coordinate-converted images on a screen in association with information specifying ejection amounts of the processing liquid ejected to substrates from which corresponding images are captured, and determining an ejection amount of the processing liquid ejected to the substrates upon forming a coating film of the processing liquid based on an instruction of a user regrading display content of the screen.

### TECHNICAL FIELD

The present disclosure relates to a coating treatment method, a non-transitory computer-readable storage medium, and a coating treatment device.

### BACKGROUND

Patent Document 1 discloses automatically adjusting coating conditions when coating a substrate with a processing liquid. Specifically, Patent Document 1 discloses that a coating speed and supply period of the processing liquid are adjustable as the coating conditions.

### PRIOR ART DOCUMENT

### Patent Document

Patent Document 1: Japanese Laid-Open Patent Publication No. 2021-044500

### SUMMARY

The present disclosure provides some embodiments of a technique capable of determining an ejection amount of a processing liquid by which a film may be appropriately formed on a surface of a substrate.

According to one embodiment of the present disclosure, a coating treatment method includes individually acquiring surface images of a plurality of substrates, wherein different films are formed on surfaces of the plurality of substrates by supplying a processing liquid of different ejection amounts; obtaining a plurality of polar-coordinate-converted images by converting the surface images of the plurality of substrates to polar coordinates, respectively; displaying one or more polar-coordinate-converted images of the plurality of polar-coordinate-converted images on a screen in association with information specifying the different ejection amounts of the processing liquid ejected to the plurality of substrates from which the one or more polar-coordinate-converted images are captured; and determining the different ejection amounts of the processing liquid ejected to the plurality of substrates when forming the different films of the processing liquid based on an instruction of a user relating to a display content on the screen.

According to the present disclosure, it is possible to provide a technique capable of determining an ejection amount of a processing liquid by which a film may be appropriately formed a surface of a substrate.

### BRIEF DESCRIPTION OF DRAWINGS

FIG. 1 is a view showing a schematic configuration of a substrate processing apparatus according to one exemplary embodiment.

FIG. 2 is a schematic diagram showing a schematic configuration of a coating unit.

FIG. 3 is a block diagram showing a functional configuration of a controller.

FIG. 4 is a block diagram showing a hardware configuration of the controller.

FIG. 5 is a sequence diagram showing a procedure of producing a condition determination sample and capturing an image.

FIG. 6 is a sequence diagram showing a procedure of determining an ejection amount based on the image.

FIG. 7 is a diagram exemplarily showing display contents in a display part.

FIG. 8 is a diagram exemplarily showing display contents in the display part.

FIG. 9 is a sequence diagram showing a procedure of producing a confirmation sample and capturing an image.

FIG. 10 is a sequence diagram showing a procedure of confirming an ejection amount based on the image.

### DETAILED DESCRIPTION

Hereinafter, various exemplary embodiments will be described.

In one exemplary embodiment, a coating treatment method is provided. The coating treatment method includes individually acquiring surface images of a plurality of substrates, wherein different films are formed on surfaces of the plurality of substrates by supplying a processing liquid of different ejection amounts; obtaining a plurality of polar-coordinate-converted images by converting the surface images of the plurality of substrates to polar coordinates, respectively; displaying one or more polar-coordinate-converted images of the plurality of polar-coordinate-converted images on a screen in association with information specifying the different ejection amounts of the processing liquid ejected to the plurality of substrates from which the one or more polar-coordinate-converted images are captured; and determining the different ejection amounts of the processing liquid ejected to the plurality of substrates when forming the different films of the processing liquid based on an instruction of a user relating to a display content on the screen.

According to the above liquid coating treatment method, the one or more polar-coordinate-converted images are displayed on the screen by creating the polar-coordinate-converted images from the surface images of the plurality of substrates on which the different films are formed by the processing liquid of the different ejection amounts. Therefore, the user may determine the different ejection amounts of the processing liquid ejected to the substrates while referring to the polar-coordinate-converted images displayed on the screen. In this way, according to the above liquid coating treatment method, the user may determine the different ejection amounts of the processing liquid after checking a change in the films caused by the difference between the different ejection amounts while looking at the polar-coordinate-converted images.

In an aspect, the displaying may include displaying the surface images of the plurality of substrates prior to the converting the surface images of the plurality of substrates to polar coordinates together with the polar-coordinate-converted images.

As described above, by displaying the surface images of the substrates prior to the converting the surface images of the plurality of substrates to polar coordinates together with the polar-coordinate-converted images, the user may determine the different ejection amounts of the processing liquid ejected to the substrates while checking actual states of the substrate surfaces in addition to the polar-coordinate-converted images.

In an aspect, the displaying may include adjusting a contrast of the images displayed on the screen.

As described above, since the contrast of the images displayed on the screen may be adjusted, the user may obtain much information from the images. Thus, the user may more appropriately determine the different ejection amounts.

In an aspect, the displaying may include additionally displaying an auxiliary line indicating a distance from a peripheral edge or a center of each of the plurality of substrates with respect to the polar-coordinate-converted images.

As described above, by additionally displaying the auxiliary line indicating the distance from the peripheral edge or the center of the substrate with respect to the polar-coordinate-converted images, the user may easily recognize what changes are occurring at a position of a distance from the peripheral edge of the substrate.

In an aspect, the displaying may include displaying information specifying the plurality of substrates from which the one or more polar-coordinate-converted images are captured in association with the one or more polar-coordinate-converted images.

As described above, by displaying the information specifying the substrates from which the images are captured in association with the polar-coordinate-converted images, the user easily intuitively recognizes which substrate an image represents.

In an aspect, the displaying may include displaying two or more polar-coordinate-converted images of the plurality of polar-coordinate-converted images on the screen in association with information specifying the different ejection amounts of the processing liquid ejected to the plurality of substrates from which the two or more polar-coordinate-converted are captured and in a state in which the different ejection amounts of the processing liquid are sequentially arranged.

As described above, by displaying the two or more polar-coordinate-converted images of the plurality of polar-coordinate-converted images on the screen in a state in which the different ejection amounts of the processing liquid are sequentially arranged, the user may easily recognize changes in surface states of the substrates caused by changes in the ejection amounts of the processing liquid.

In an aspect, the displaying may include displaying a specific area of the one or more polar-coordinate-converted images in an enlarged form based on the instruction of the user.

As described above, by displaying the specific area of the images in the enlarged form, the user may check in detail, for example, a portion the user is interested in. Thus, the user may more appropriately determine the different ejection amounts from image information.

In as aspect, the coating treatment method may further include: acquiring a plurality of confirmation images by individually acquiring the surface images of the plurality of substrates, wherein the different films are formed on the surfaces of the plurality of substrates formed by supplying the processing liquid of the different ejection amounts determined in the determining to each of the plurality of substrates; displaying the plurality of confirmation images on the screen; and finalizing the different ejection amounts of the processing liquid in a substrate processing condition based on the instruction of the user relating to the display content on the screen.

In the above configuration, the films are formed by supplying the processing liquid of the different ejection amounts determined in the above to the plurality of substrates, and surface images of the substrates on which the films are formed are captured. The different ejection amounts of the processing liquid in the substrate processing condition are finalized based on the instruction of the user with reference to the surface images. With this configuration, for example, whether the state of the substrate surfaces when the images are acquired to determine the different ejection amounts is accidental or normal may be confirmed. Therefore, the finalized substrate processing condition in finalizing the different ejection amounts is suitable for processing the plurality of substrates.

In one exemplary embodiment, a non-transitory computer-readable storage medium is provided. The storage medium is a non-transitory computer-readable storage medium storing a program for causing an apparatus to execute the aforementioned coating treatment method. In this case, the same effects as in the coating treatment method may be obtained.

In one exemplary embodiment, a coating treatment device is provided. The coating treatment device includes an image acquirer configured to individually acquire surface images of a plurality of substrates, wherein different films are formed on surfaces of the plurality of substrates by supplying a processing liquid of different ejection amounts; an image converter configured to obtain a plurality of polar-coordinate-converted images by converting the surface images of the plurality of substrates to polar coordinates, respectively; a display part configured to display one or more polar-coordinate-converted images of the plurality of polar-coordinate-converted images on a screen in association with information specifying the different ejection amounts of the processing liquid ejected to the plurality of substrates from which the one or more polar-coordinate-converted images are captured; and an ejection amount determiner configured to determine the different ejection amounts of the processing liquid ejected to the plurality of substrates when forming the different films of the processing liquid based on an instruction of a user relating to a display content on the screen.

According to the above liquid coating treatment device, the one or more polar-coordinate-converted images are displayed on the screen by creating the polar-coordinate-converted images from the surface images of the plurality of substrates on which the films are formed by the processing liquid of different ejection amounts. Therefore, the user may determine the different ejection amounts of the processing liquid ejected to the substrates while referring to the polar-coordinate-converted images displayed on the screen. As described above, according to the above liquid coating treatment device, the user may determine the different ejection amounts of the processing liquid after checking a change in the films caused by the difference between the different ejection amounts while looking at the polar-coordinate-converted images.

### Exemplary Embodiments

Hereinafter, various exemplary embodiments will be described in detail with reference to the drawings. Like reference numerals will be given to like or corresponding parts throughout the drawings, and redundant description thereof will be omitted.

### Substrate Processing System

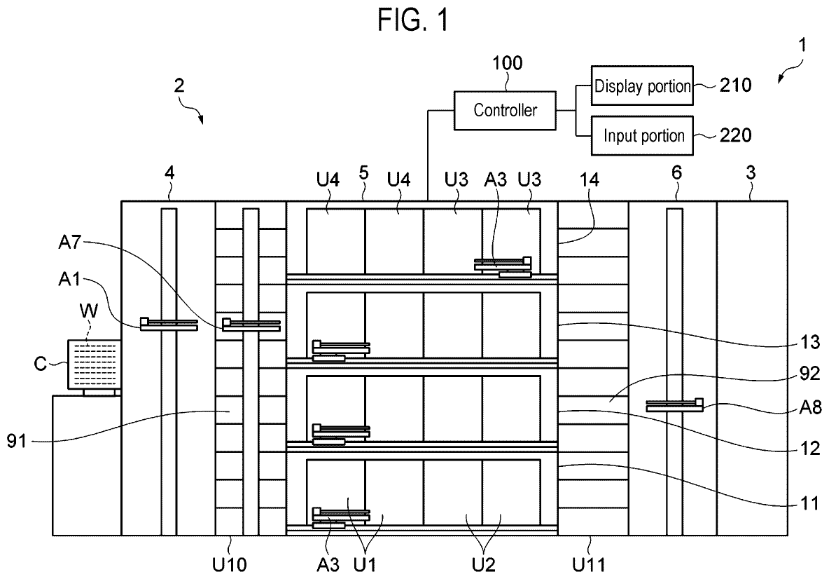

As shown in FIG. 1, a substrate processing system 1 is a system which forms a photosensitive film on a substrate, exposes the photosensitive film, and develops the photosensitive film.

A workpiece W (substrate) to be processed is, for example, a semiconductor substrate. One example of the substrate is a silicon wafer. The workpiece W may be formed in a circular shape. The workpiece W to be processed may also be a glass substrate, a mask substrate, a flat panel display (FPD), or the like. The workpiece W may have a cutout portion in which a part thereof is cut out. The cutout portion may be, for example, a notch (a U-shaped or V-shaped groove) or a linear portion that extends linearly (a so-called orientation flat). The photosensitive film is, for example, a resist film.

The substrate processing system 1 includes a coating/developing apparatus 2 and an exposure apparatus 3. The exposure apparatus 3 performs an exposure process on the resist film (photosensitive film) formed on the workpiece W (substrate). Specifically, the exposure apparatus 3 irradiates an exposure target portion of the resist film with energy rays by a method such as liquid immersion exposure. The coating/developing apparatus 2 performs a process of forming the resist film on the surface of the workpiece W before performing the exposure process by the exposure apparatus 3, and performs a process of developing the resist film after performing the exposure process.

### Liquid Processing Apparatus

Hereinafter, a configuration of the coating/developing apparatus 2 will be described as an example of a liquid processing apparatus. The coating/developing apparatus 2 includes a carrier block 4, a processing block 5, an interface block 6, and a controller 100. In addition, a display part 210 and an input part 220 are connected to the controller 100.

The carrier block 4 loads the workpiece W into the coating/developing apparatus 2 and unloads the workpiece W from of the coating/developing apparatus 2. For example, the carrier block 4 may support a plurality of carriers C for workpieces W and incorporates a delivery arm A1. The carrier C accommodates, for example, a plurality of sheets of circular workpieces W. The delivery arm A1 takes the workpiece W out of the carrier C to deliver the workpiece W to the processing block 5, and receives the workpiece W from the processing block 5 to return the workpiece W to the carrier C.

The processing block 5 has a plurality of processing modules 11, 12, 13, and 14. Each of the processing modules 11, 12, and 13 incorporates a coating unit U1, a heat treatment unit U2, and a transfer arm A3 that transfers the workpiece W to these units.

The processing module 11 forms a lower layer film on the surface of the workpiece W by the coating unit U1 and the heat treatment unit U2. The coating unit U1 of the processing module 11 coats the workpiece W with a film-forming liquid for forming the lower layer film. The heat treatment unit U2 of the processing module 11 performs various heat treatments associated with formation of the lower layer film.

The processing module 12 forms a resist film on the lower layer film by the coating unit U1 and the heat treatment unit U2. The coating unit U1 of the processing module 12 coats the lower layer film with a film-forming liquid for forming the resist film (hereinafter referred to as “resist liquid”). The heat treatment unit U2 of the processing module 12 performs various heat treatments associated with formation of the resist film.

The processing module 12 may further include a substrate cooler 91 and a surface inspector 92. The substrate cooler 91 cools the workpiece W before the coating unit U1 coats the workpiece W with the resist liquid. The surface inspector 92 acquires, as an image, a state of the resist film formed on a surface Wa of the workpiece W. The surface inspector 92 acquires a pixel value from a captured image of the front surface Wa of the workpiece W. The pixel value is a numerical value indicating the state of each of pixels constituting the image. For example, the pixel value is a numerical value indicating a shading level of color of a pixel (for example, a gray level in a black and white image). £ In addition, in the captured image of the front surface Wa, the pixel value correlates with a height of a portion to be captured, corresponding to the pixel. In other words, the pixel value also correlates with a thickness of the resist film in the portion to be captured.

The processing module 13 forms an upper layer film on the resist film by the coating unit U1 and the heat treatment unit U2. The coating unit U1 of the processing module 13 coats the resist film with a film-forming liquid for forming the upper layer film. The heat treatment unit U2 of the processing module 13 performs various heat treatments associated with formation of the upper layer film.

The processing module 14 incorporates a development unit U3, a heat treatment unit U4, and a transfer arm A3 which transfers the workpiece W to these units. The processing module 14 performs a development process on the resist film subjected to the exposure process by the development unit U3 and the heat treatment unit U4. The development unit U3 coats a surface of the exposed workpiece W with a developing liquid and then rinses the developing liquid with a rinsing liquid to perform the development process on the resist film. The heat treatment unit U4 performs various heat treatments associated with the development process. A specific example of the heat treatment may include heat treatment before the development process (post exposure bake (PEB)) and heat treatment after the development process (pre bake (PB)).

A shelf unit U10 is provided on a side of the carrier block 4 in the processing block 5. The shelf unit U10 is partitioned into a plurality of cells arranged in a vertical direction. An elevating arm A7 is provided in the vicinity of the shelf unit U10. The elevating arm A7 raises and lowers the workpiece W between the cells of the shelf unit U10.

A shelf unit U11 is provided on a side of the interface block 6 in the processing block 5. The shelf unit U11 is partitioned into a plurality of cells arranged in a vertical direction.

The interface block 6 delivers the workpiece W to and from the exposure apparatus 3. For example, the interface block 6 incorporates a delivery arm A8 and is connected to the exposure apparatus 3. The delivery arm A8 delivers the workpiece W placed on the shelf unit U11 to the exposure apparatus 3. The delivery arm A8 receives the workpiece W from the exposure apparatus 3 and returns the workpiece W to the shelf unit U11.

The controller 100 has a function of storing programs for operating each part of the coating/developing apparatus 2 or each part of the exposure apparatus 3 and controlling operations of these apparatuses. The display part 210 connected to the controller 100 is, for example, a monitor. The monitor may be of any type capable of displaying information on a screen, and a specific example thereof may be a liquid crystal panel. The display part 210 may have a function of displaying contents of control by the controller 100. Further, the display part 210 displays, using the controller 100, information to be referred to by a user (such as an operator who uses a device) when setting conditions for processing the workpiece W. This point will be described later.

Further, the input part 220 may be provided such that the user inputs various conditions thereto. In this case, the controller 100 may operate each part of the coating/developing apparatus 2 or each part of the exposure apparatus 3 according to conditions input to the controller 100 through the input part 220. The input part 220 may be, for example, a mouse, a touch panel, a pen tablet, and/or a keyboard.

The controller 100, the display part 210, and the input part 220 may be provided in the vicinity of a place in which a part (substrate processor) for actually performing processing on the workpiece W except for the controller 100 out of the coating/developing apparatus 2 is installed. These functional portions may also be provided at a location separated from the substrate processor. In particular, the display part 210 and the input part 220 that are actually operated by the user may be provided at locations separated from a main body of the coating/developing apparatus 2. In that case, the display part 210, the input part 220, and the controller 100 may be connected to each other in a wired or wireless manner.

The controller 100 controls the coating/developing apparatus 2 so as to execute a coating/developing process in, for example, the following procedure. First, the controller 100 controls the delivery arm Al so as to transfer the workpiece W in the carrier C to the shelf unit U10 and controls the elevating arm A7 so as to dispose the workpiece W in a cell for the processing module 11.

Subsequently, the controller 100 controls the transfer arm A3 so as to transfer the workpiece W on the shelf unit U10 to the coating unit U1 and the heat treatment unit U2 in the processing module 11. Thereafter, the controller 100 controls the coating unit U1 and the heat treatment unit U2 so as to form the lower layer film on the surface of the workpiece W. Thereafter, the controller 100 controls the transfer arm A3 so as to return the workpiece W on which the lower layer film is formed to the shelf unit U10 and controls the elevating arm A7 so as to place the workpiece W in the cell for the processing module 12.

Subsequently, the controller 100 controls the transfer arm A3 so as to transfer the workpiece W on the shelf unit U10 to the coating unit U1 and the heat treatment unit U2 in the processing module 12 and controls the coating unit U1 and the heat treatment unit U2 so as to form a resist film on the lower layer film of the workpiece W. Thereafter, the controller 100 controls the transfer arm A3 so as to return the workpiece W to the shelf unit U10 and controls the elevating arm A7 so as to dispose the workpiece W in the cell for the processing module 13. The controller 100 may also control the transfer arm A3 such that the workpiece W is cooled down by the substrate cooler 91 before processing the workpiece W in the coating unit U1. Further, the controller 100 may control the transfer arm A3 such that the surface inspector 92 acquires an image of the front surface Wa of the workpiece W after processing the workpiece W (coating of a resist liquid) in the coating unit U1.

Subsequently, the controller 100 controls the transfer arm A3 so as to transfer the workpiece W on the shelf unit U10 to each unit in the processing module 13 and controls the coating unit U1 and the heat treatment unit U2 so as to form the upper layer film on the resist film of the workpiece W. Thereafter, the controller 100 controls the transfer arm A3 so as to transfer the workpiece W to the shelf unit U11.

Subsequently, the controller 100 controls the delivery arm A8 to send the workpiece W on the shelf unit U11 to the exposure apparatus. Thereafter, the controller 100 controls the delivery arm A8 so as to receive the exposed workpiece W from the exposure apparatus and dispose the workpiece W in the cell for the processing module 14 in the shelf unit U11.

Subsequently, the controller 100 controls the transfer arm A3 so as to transfer the workpiece W on the shelf unit U11 to each unit in the processing module 14 and controls the developing unit U3 and the heat treatment unit U4 so as to perform the development process on the resist film of the workpiece W. Thereafter, the controller 100 controls the transfer arm A3 so as to return the workpiece W to the shelf unit U10 and controls the elevating arm A7 and the delivery arm Al so as to return the workpiece W to the carrier C. In the way, the coating/developing process is completed.

A specific configuration of the substrate processing apparatus is not limited to the configuration of the coating/developing apparatus 2 exemplified above. The substrate processing apparatus may be of any type as long as it includes the coating unit U1, the surface inspector 92, and the controller 100 capable of controlling the coating unit U1 and the surface inspector 92.

### Coating Unit

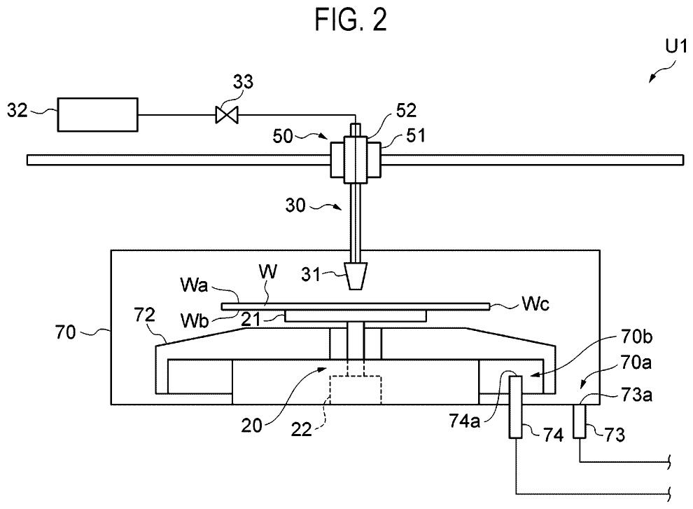

Next, a configuration of the coating unit U1 of the processing module 12 will be described in detail. As shown in FIG. 2, the coating unit U1 includes a rotational holder 20, a liquid supplier 30, a nozzle transferer 50, and a cup 70.

The rotational holder 20 rotates the workpiece W while holding a back surface Wb of the workpiece W. For example, the rotational holder 20 includes a holder 21 and a rotational driver 22. The holder 21 supports the center (a portion including the center) of the workpiece W, which is placed horizontally with a front surface Wa upward, from the side of the back surface Wb, and holds the workpiece W by, for example, vacuum suction. The rotational driver 22 rotates the holder 21 around a vertical axis line passing through the center of the workpiece W by using, for example, an electric motor as a power source. This causes the workpiece W to rotate as well.

The liquid supplier 30 supplies a resist liquid to the center of the front surface Wa of the workpiece W held by the rotational holder 20. For example, the liquid supplier 30 includes a nozzle 31, a liquid source 32, and a valve 33.

The nozzle 31 ejects the resist liquid downward. The liquid source 32 (a source of a film-forming liquid) supplies the resist liquid to the nozzle 31. For example, the liquid source 32 includes a tank for storing the resist liquid and a pump for pumping the resist liquid. The liquid source 32 may be configured to adjust a liquid supply pressure for the resist liquid by the pump or the like. The valve 33 opens and closes a flow path through which the resist liquid flows from the liquid source 32 to the nozzle 31.

The nozzle transferer 50 transfers the nozzle 31 of the liquid supplier 30. For example, the nozzle transferer 50 includes a horizontal transferer 51 and a lifer 52. The horizontal transferer 51 transfers the nozzle 31 along a horizontal transfer line using, for example, an electric motor as a power source. The lifter 52 raises and lowers the nozzle 31 using, for example, the electric motor as the power source.

The cup 70 accommodates the workpiece W together with the holder 21 and collects various processing liquids (for example, resist liquid) that have been dropped from the workpiece W. The cup 70 includes an umbrella part 72, a drainage part 73, and an exhauster 74. The umbrella part 72 is provided below the holder 21 and guides various processing liquids that have been dropped from the workpiece W up to a drainage area 70a on an outer periphery of the cup 70. The drainage part 73 has a drainage port 73a opened in the cup 70 (an accommodation space of the workpiece W) below the umbrella part 72 (i.e., below the back surface Wb of the workpiece W) and discharges the processing liquid from the drainage port 73a outward of the cup 70. For example, the drainage port 73a is provided below the umbrella part 72 in the drainage area 70a. Therefore, the processing liquid guided to the drainage area 70a by the umbrella part 72 is discharged from the drain port 73a outward of the cup 70.

The exhauster 74 has an exhaust port 74a opened in the cup 70 below the holder 21 (i.e., below the back surface Wb of the workpiece W) and discharges gas in the cup 70 (gas in the accommodation space of the workpiece W) from the exhaust port 74a outward of the cup 70. For example, the exhaust port 74a is provided below the umbrella part 72 in an exhaust area 70b defined inward of the drainage area 70a. Therefore, gas flowing from the drainage area 70a to the exhaust area 70b is discharged from the exhaust port 74a outward of the cup 70.

The coating unit U1 configured as above is controlled by the controller 100. The controller 100 rotates the workpiece W by the rotational holder 20 at a predetermined rotational speed while supplying the resist liquid to the center of the front surface Wa of the workpiece W by the liquid supplier 30. In addition, the controller 100 stops the supply of the resist liquid by the liquid supplier 30 before the resist liquid supplied to the front surface Wa reaches an outer periphery Wc of the workpiece W. In addition, there are cases in which the rotation of the workpiece W is continuously performed at a predetermined rotational speed by the rotational holder 20 even after the supply of the resist liquid by the liquid supplier 30 is stopped. The controller 100 is configured to execute such coating control.

### Controller

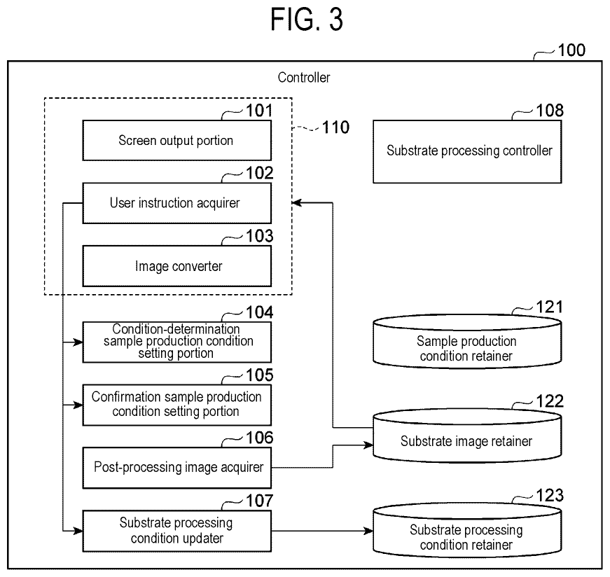

The controller 100 is a functional unit for determining an ejection amount, as a processing condition when forming the resist film on the workpiece W, using the coating/developing apparatus 2. When forming the resist film on the workpiece W, the amount of the resist liquid to be supplied to the workpiece W may be varied depending on a type of the resist liquid. For example, since the resist liquid is generally expensive, it is important that the amount of the resist liquid supplied to the workpiece W is as small as possible. Meanwhile, if the supply amount of the resist liquid is too small, the resist liquid may not be uniformly coated on the front surface Wa of the workpiece W. In order to confirm conditions under which the resist film may be appropriately formed with a relatively small ejection amount (supply amount) of the resist liquid, a procedure is required in which a plurality of workpieces W on which the resist films have been formed with different ejection amounts is prepared and the user checks a state of a surface of each of the workpieces W. Therefore, in the controller 100, the workpieces W on which processing has been performed under conditions in which the ejection amounts of the resist liquid are different from each other based on an instruction of the user, are prepared. Further, in the controller 100, images of the front surfaces Wa of the workpieces W on which the resist film has been formed under different conditions are presented to the user so as to easily confirm the states of the workpieces W after processing. Further, in the controller 100, control is executed in order for the user to confirm whether it is okay to perform processing on the workpiece W for actual production using a condition (ejection amount) selected by the user. Hereinafter, each part of the controller 100 for performing the above operations will be described. As shown in FIG. 3, the controller 100 includes, as functional configurations (hereinafter referred to as “functional modules”), a screen outputter 101, a user instruction acquirer 102, an image converter 103, a condition-determination sample production condition setter 104, a confirmation sample production condition setter 105, a processed-image acquirer 106, a substrate processing condition updater 107, a substrate processing controller 108, a sample production condition retainer 121, a substrate image retainer 122, and a substrate processing condition retainer 123. Among these, the screen outputter 101, the user instruction acquirer 102, and the image converter 103 present various information to the user on the monitor functioning as the display part 210 and also function as a user interface 110 for acquiring information indicated by the user referring to the display part 210 using the input part 220 and the like.

The screen outputter 101 has a function of controlling the display part 210 so as to display various information thereon based on the instruction of the user.

The user instruction acquirer 102 has a function of acquiring an instruction from the user performed using the input part 220 or the like. Based on the instruction of the user acquired by the user instruction acquirer 102, various control operations are performed by the controller 100.

The image converter 103 has a function of performing processing of an image when the display part 210 displays the image obtained by capturing the surface surface of the workpiece W after processing. Example of the processing of the image may include polar coordinate conversion, contrast conversion (emphasis) and the like. However, other image processing other than these types of processing may be performed.

The condition-determination sample production condition setter 104 has a function of producing a sample for determining a condition during formation of the resist film. That is, the condition-determination sample production condition setter 104 sets a condition for preparing a plurality of types of workpieces W on which the resist film has been formed under conditions in which ejection amounts of the resist liquid are different from each other. Details of the condition are instructed by the user. Therefore, the condition-determination sample production condition setter 104 determines a condition for producing a sample for condition determination based on an instruction of the user, and a substrate processing condition used when producing the sample for condition determination, which is retained in the sample production condition retainer 121 described later.

The confirmation sample production condition setter 105 has a function of producing a sample to confirm whether the corresponding condition may be used in actual production after the user has determined the ejection amount once. At this stage, a plurality of workpieces W is processed with the ejection amount of the resist liquid set by the user. Details of the condition are indicated by the user. Therefore, the confirmation sample production condition setter 105 determines a condition for producing a confirmation sample based on the instruction of the user, and the substrate processing condition used when producing the confirmation sample, which is retainer in the sample production condition retainer 121 described later.

The processed-image acquirer 106 has a function of acquiring an image obtained by capturing the workpiece W after forming the resist film produced as the condition determination sample or the confirmation sample. Specifically, the processed-image acquirer 106 controls each part so as to capture the image of the front surface Wa of the workpiece W after processing in the surface inspector 92 and acquires the resultant image. The captured image is retained in the substrate image retainer 122 in association with information specifying a condition when the resist film has been formed on the workpiece W.

The substrate processing condition updater 107 has a function of updating a condition related to an ejection amount of the resist liquid ejected to the workpiece W during actual production based on the instruction of the user. The condition related to the ejection amount of the resist liquid is retained in the substrate processing condition retainer 123 described later.

The substrate processing controller 108 has a function of controlling each part of the coating/developing apparatus 2 so as to form the resist film on the workpiece W based on the conditions set by the condition-determination sample production condition setter 104 and the confirmation sample production condition setter 105. The substrate processing controller 108 also has a function of controlling each part of the coating/developing apparatus 2 so as to form the resist film on the workpiece W during actual production based on the substrate processing condition which is updated by the substrate processing condition updater 107 and retained in the substrate processing condition retainer 123.

The sample production condition retainer 121 has a function of retaining an operation condition of each part of the coating/developing apparatus 2 when producing the condition determination sample and an operation condition of each part of the coating/developing apparatus 2 when producing the confirmation sample. The sample production condition retainer 121 retains information about operation conditions other than the condition related to the ejection amount of the resist liquid set based on the instructions of the user among the operation conditions of each part of the coating/developing apparatus 2.

When determining the ejection amount of the resist liquid, the operation conditions (for example, the number of rotations of the workpiece W) other than the condition related to the ejection amount of the resist liquid are assumed to be determined in advance. In other words, in a process of forming the resist film on one sheet of workpiece W, the conditions other than the ejection amount of the resist liquid are assumed to be determined in advance. The sample production condition retainer 121 retains the conditions other than the ejection amount of the resist liquid among the operation conditions of each part when forming the resist film on one sheet of workpiece W.

The substrate image retainer 122 has a function of retaining the image of the front surface Wa of the workpiece W after processing, which is captured by the surface inspector 92, based on the instruction of the processed-image acquirer 106. In this case, the substrate image retainer 122 retains information specifying the ejection amount of the resist liquid ejected to each workpiece W as a processing condition of the workpiece W in association with each captured image. The information specifying the ejection amount of the resist liquid to be discharged onto the workpiece W may be a numerical value specifying the ejection amount. In addition, when information about an operation condition of each workpiece W including the ejection amount of the resist liquid is specified by, for example, identification information (such as an ID), the identification information may be configured to correspond to each captured image. The configuration of the information about the operation condition may be used without any particular limitation as long as it is possible to present to the user the ejection amount of the resist liquid ejected to the workpiece W when displaying the image of the front surface Wa of the workpiece W on the display part 210.

The substrate processing condition retainer 123 has a function of retaining an operation condition of each part of the coating/developing apparatus 2 during actual production. During the actual production, an operation related to the formation of the resist film is performed based on the ejection amount of the resist liquid designated by the user. Information retained in the substrate processing condition retainer 123 also includes information related to the ejection amount of the resist liquid designated by the user. When the ejection amount of the resist liquid designated by the user is changed, the information retained in the substrate processing condition retainer 123 may be updated by the substrate processing condition updater 107.

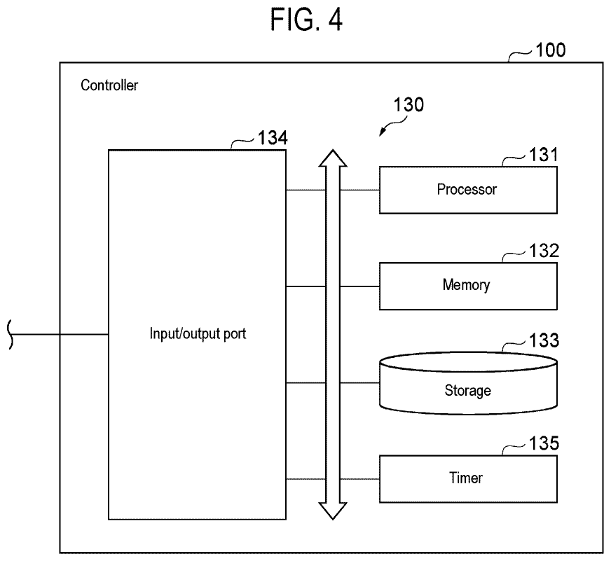

The controller 100 may be constituted with one or more control computers. For example, the controller 100 includes a circuit 130 shown in FIG. 4. The circuit 130 includes one or more processors 131, a memory 132, a storage 133, an input/output port 134, and a timer 135.

The storage 133 includes a non-transitory computer-readable storage medium such as a hard disk or the like. The storage medium stores a program for causing the coating/developing apparatus 2 to execute a substrate processing procedure which will be described later. The storage medium may be a removable medium such as a non-volatile semiconductor memory, a magnetic disk, an optical disc, or the like. The memory 132 temporarily records a program loaded from the storage medium of the storage 133 and a calculation result by the processor 131. The processor 131 cooperates with the memory 132 to execute the above program, thereby constituting each of the above-described functional modules. The input/output port 134 inputs and outputs an electrical signal to and from each part of the liquid supplier 30.

A hardware configuration of the controller 100 is not necessarily limited to one that configures each functional module by a program. For example, each functional module of the controller 100 may be configured by a dedicated logic circuit or an application specific integrated circuit (ASIC) in which the dedicated logic circuit is integrated.

### Liquid Processing Method

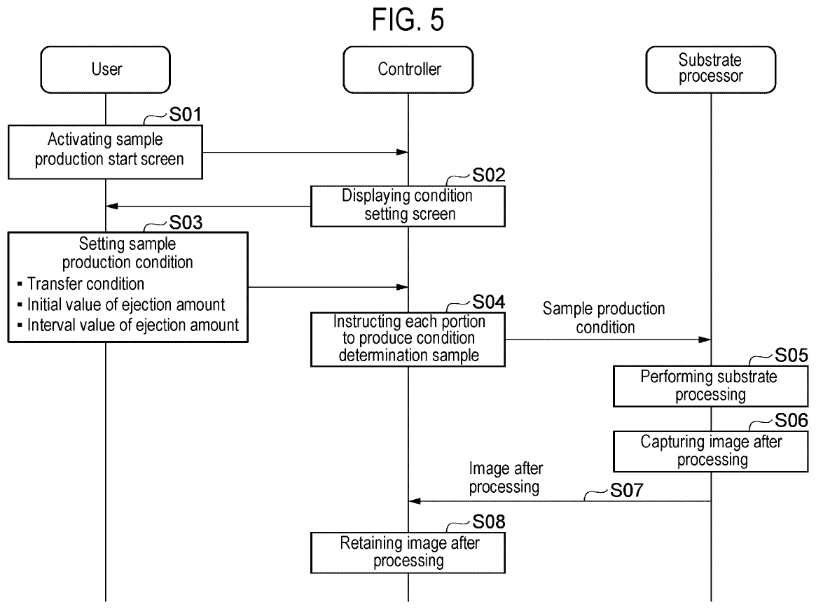

A liquid processing method using the above-described liquid processing apparatus will now be described with reference to FIGS. 5 to 10. A description of the liquid processing method may also include a description of an example of a display method in the display part 210.

### Producing Condition Determination Sample and Capturing Image

FIG. 5 is a diagram showing an example of a procedure of producing a condition determination sample and capturing an image. First, the user activates a sample production start screen by operating the input part 220 (step S01). In the controller 100, when the user instruction acquirer 102 acquires an instruction from the user, the screen outputter 101 controls the display part 210 to display a condition setting screen thereon (step S02). Then, the user sets a sample production condition while referring to the condition setting screen (step S03). Specifically, the sample production condition may include specifying a transfer condition of the workpiece W (such as specifying a unit which transfers the workpiece W), an initial value of an ejection amount (a minimum value of the ejection amount of the resist liquid ejected to the workpiece W when producing the condition determination sample), an increment value of the ejection amount (how much will the ejection amount be increased from the initial value to produce a plurality of samples), and the like. Further, an upper limit value of the ejection amount or the like may be set. When the user inputs such information by operating the input part 220, the user instruction acquirer 102 of the controller 100 acquires an instruction from the user. The condition-determination sample production condition setter 104 determines a processing condition of the workpiece W for producing the condition determination sample, based on the information acquired from the user and the information retained in the sample production condition retainer 121. When the preparation is completed, the substrate processing controller 108 of the controller 100 controls each part of the coating/developing apparatus 2 functioning as a substrate processor to produce the sample based on the sample production conditions (step S04). The substrate processor (each part of the coating/developing apparatus 2) performs the substrate processing based on the sample production condition to produce a sample on which the resist film is formed (step S05). In addition, the workpiece W after the formation of the resist film is transferred to the surface inspector 92 where an image after processing is captured (step S06). The image captured by the surface inspector 92 is sent to the controller 100, and the processed-image acquirer 106 acquires the image (S07). The image is retained in the substrate image retainer 122 in association with information about the ejection amount of the resist liquid (step S08).

### Determining Ejection Amount Based on Image

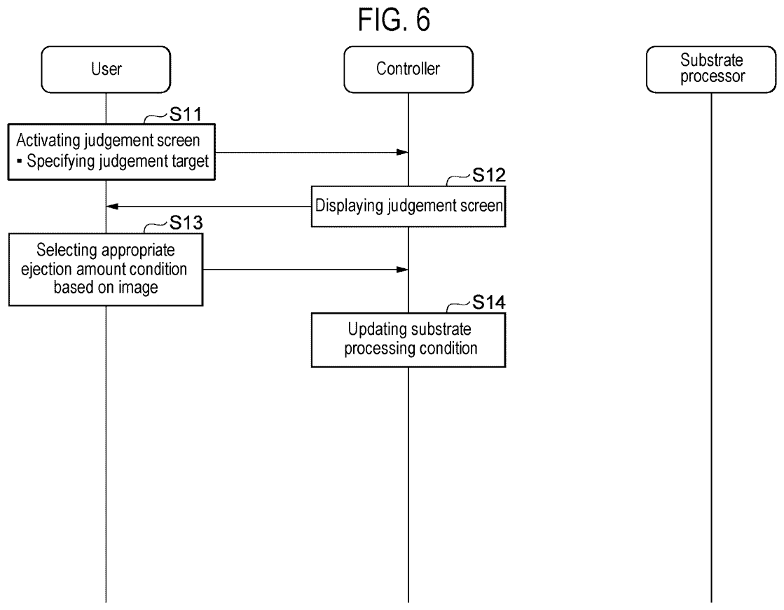

FIG. 6 is a diagram showing an example of a procedure in which the user determines the ejection amount of the resist liquid based on the image after processing, which is acquired through the procedure shown in FIG. 5. At this stage, the user checks, based on the image, a state of the resist film formed on the surface surface of each of the plurality of workpieces W, which are produced by supplying the resist liquid at different ejection amounts. The user determines whether the resist film is uniformly formed (OK) or not (NG) with respect to every workpiece W while looking at the image. As a result, in the workpieces W on which the resist film is uniformly formed, a condition under which the ejection amount of the resist liquid is smallest is specified as an ejection amount of the resist liquid used in the actual production.

First, the user activates a screen used to determine an ejection amount (determination screen) by operating the input part 220 (step S11). In this case, the user specifies data to be determined, i.e., data to be used to determine the ejection amount of the resist liquid, by specifying a lot number or the like.

When the user instruction acquirer 102 acquires an instruction from the user, the controller 100 controls the screen outputter 101 such that the display part 210 displays the determination screen (step S12). The determination screen includes the image of the workpiece W after processing, which corresponds to the condition of the resist liquid to be determined.

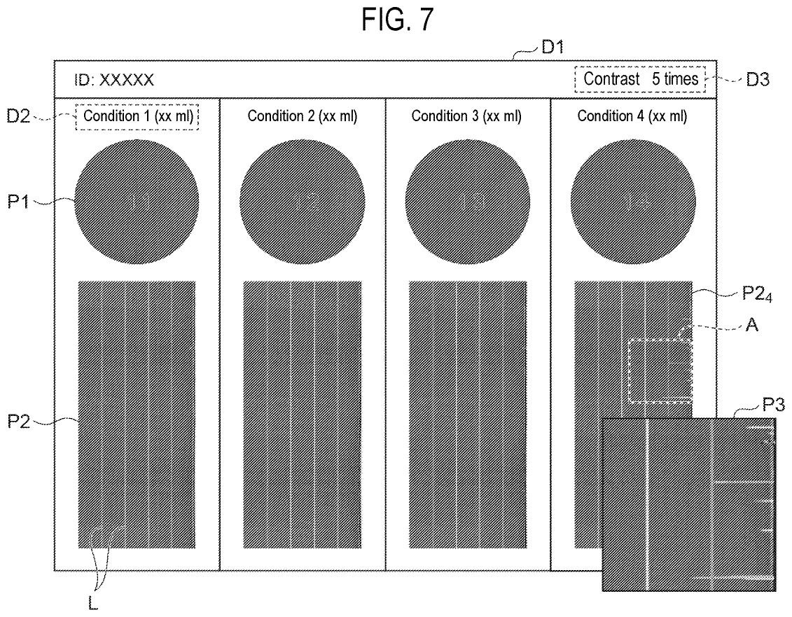

FIG. 7 illustrates an example in which the image of the workpiece W after processing is displayed. As shown in FIG. 7, images of the plurality of workpieces W after processing may be displayed on a display screen D1 in the display part 210. In the example shown in FIG. 7, images for four sheets of workpieces W processed under different conditions (Conditions 1 to 4) are displayed. In addition, an amount D2 of a resist liquid corresponding to each of Conditions 1 to 4 may be displayed. When a plurality of images after processing is arranged, for example, Conditions 1 to 4 may be arranged in order of the ejection amount. When the images are arranged in order of the ejection amount, the user may easily recognize a relationship between a change in the ejection amount and a change in the image.

On the display screen D1, a numeric character is represented inside an image P1 obtained by capturing the front surface Wa of the workpiece W. This numeric character is information specifying the workpiece W. In this way, the information specifying the workpiece W may be displayed in addition to the processing conditions. In addition, information specifying a slot in which the workpiece W is held may be used as the information specifying the workpiece W.

In addition to the image P1 obtained by capturing the front surface Wa of each of the four sheets of workpieces W, a polar-coordinate-converted image P2 may be displayed. The polar-coordinate-converted image refers to an image obtained by converting orthogonal coordinates of each position in the image into polar coordinates and representing each pixel using the polar coordinates. An image of the polar coordinates is created by the image converter 103. A known method may be used to convert the orthogonal coordinates into the polar coordinates. The polar-coordinate-converted image P2 shown in FIG. 7 is denoted such that the center of the workpiece W is a reference (origin), a distance from the origin is a horizontal axis, and an angle is a vertical axis. Therefore, in the image P2, a left end is the center of the workpiece W, and a right end is a peripheral edge of the workpiece W. In an image P24 of Condition 4, for example, a bright line is observed on the right side of the image representing the peripheral edge. This bright line is caused due to occurrence of an uncoated area (dry patch) for reasons such as a lack of the resist liquid on the surface surface of the workpiece W. When such an uncoated area is formed on the workpiece W in the actual production, a defective product may be generated. On the display screen D1, the user selects a condition that may be used in the actual production while visually checking whether any events that may lead to the generation of the defective product have occurred among the workpieces W captured under the respective conditions.

In addition to displaying the images P1 and P2 of the workpiece W, images which have been subjected to various image processing based on the instruction from the user, may be displayed in the display screen D1.

For example, an auxiliary line L may also be displayed on the polar-coordinate-converted image P2, so that the user may be easily aware of a distance from the workpiece W (or a distance from the center of the workpiece W). As in the example shown in FIG. 7, a plurality of auxiliary lines L may be arranged at a predetermined interval (for example, an interval of 1 mm to several mm). For example, the interval may be narrow in the vicinity of a peripheral portion of the workpiece W and broad in an inner side of the workpiece W. Further, the number of auxiliary lines L may be one.

In addition, when the user selects a certain area A, an enlarged image P3 of the area may be displayed. When the enlarged image P3 is configured to be displayed, the user may check a state of the front surface Wa of the workpiece W in more detail under each condition.

Further, the user may specify contrast so as to be aware of a change in color of the front surface Wa of the workpiece W in detail in the images P1 to P3. In the example shown in FIG. 7, a contrast D3 specified by the user is five times. By adjusting the contrast, a state in which a change in color of the front surface Wa is emphasized may be formed.

In this way, while looking at the screen D1, the user selects a condition under which the ejection amount of the resist liquid is smallest from among the workpieces W on which the resist film is uniformly formed and sets the selected ejection amount as an ejection amount during the actual production.

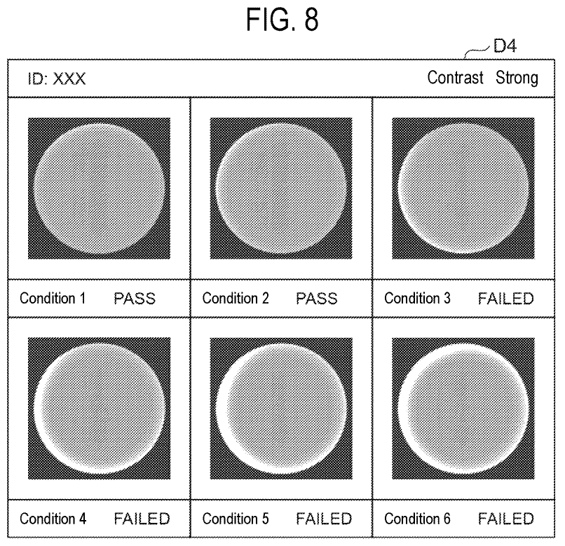

FIG. 8 illustrates another example in which an image of the workpiece W after processing is displayed. In the example shown in FIG. 8, a display screen D4 is shown in which only images of the front surfaces Wa of the plurality of workpieces W (six sheets of workpieces in this case) are arranged. In the display screen D4, it is possible to increase the number of workpieces W which may be displayed compared to the display screen D1 shown in FIG. 7. In addition, by adjusting the contrast, it is easier to compare the overall color non-uniformity of each workpiece W. In the example shown in FIG. 8, the workpieces W under Conditions 3 to 6 are in a state in which color non-uniformity between the center and the peripheral edge is clearly visible. Therefore, the user has determined that the resist film has not been uniformly formed (as indicated by FAILED).

In this way, a display screen in the display part 210 may be appropriately changed. As shown in FIG. 8, the display screen D4 which does not show the polar-coordinate-converted image P2 may be displayed based on an instruction of the user. Although not shown in the figure, a display screen on which only a plurality of polar-coordinate-converted images P2 is arranged may be set.

Returning to FIG. 6, the user selects an ejection amount condition while referring to the determination screen displayed as shown in FIGS. 7 and 8 (step S13). For example, as shown in FIG. 8, the user determines “PASS (the resist film has been uniformly formed; OK)” or “FAILED (the resist film has not been uniformly formed; NG)” while looking at the image of each workpiece W. As a result, a condition under which the ejection amount of the resist liquid is smallest among the workpieces W on which the resist film is uniformly formed is specified. This condition is set as the ejection amount of the resist liquid during the actual production. When the user performs a determination operation, the result of the determination operation is acquired by the user instruction acquirer 102. When the condition under which the ejection amount of the resist liquid is smallest is specified by these operations, the substrate processing condition is updated by the substrate processing condition updater 107 of the controller 100 based on information about the determined condition (step S14). As a result, the condition for the ejection amount of the resist liquid during the actual production is updated based on the result determined by the user.

### Producing Condition Confirmation Sample and Capturing Image

Next, in order to confirm whether the ejection amount of the resist liquid set in the procedure so far is suitable for the actual production, the plurality of workpieces W is processed under the same condition and its results are confirmed.

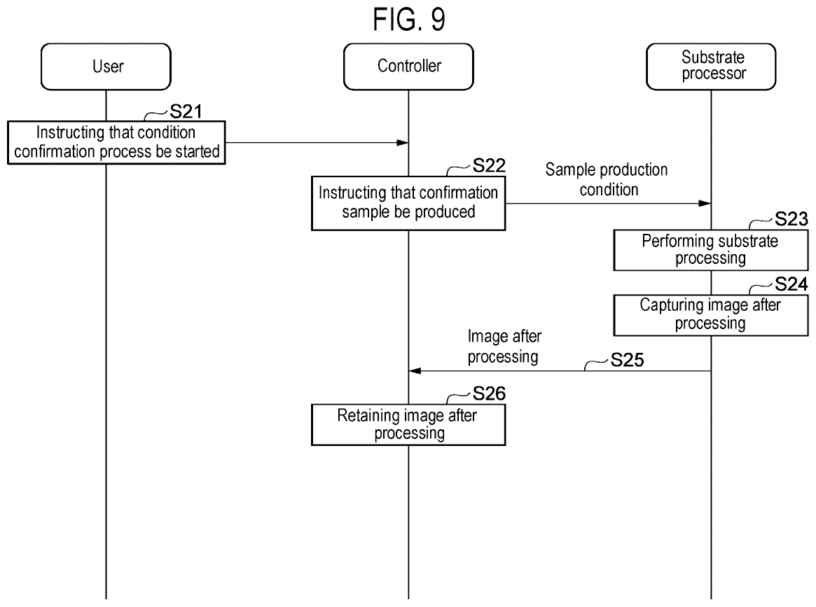

FIG. 9 is a diagram showing an example of a procedure of producing a condition confirmation sample and capturing an image. First, the user may operate the input part 220 to start a condition confirmation process (step S21). In this case, the user may indicate the number of sheets of workpieces W to be processed under the same condition. In addition, the user may specify a transfer condition of the workpiece W (such as specifying a unit which transfers the workpiece W). When the user instruction acquirer 102 acquires an instruction from the user, the controller 100 controls the substrate processing controller 108 to instruct each part of the coating/developing apparatus 2 functioning as the substrate processor so as to produce a sample based on a confirmation sample production condition (step S22). The substrate processor (each part of the coating/developing apparatus 2) performs the substrate processing based on the sample production condition to produce a sample on which the resist film is formed (step S23). In addition, the workpiece W after the formation of the resist film is transferred to the surface inspector 92 where an image after processing is captured (step S24). The image captured by the surface inspector 92 is sent to the controller 100 and the processed-image acquirer 106 acquires the image (step S25). The image is retained in the substrate image retainer 122 in association with information about the ejection amount of the resist liquid (step S26).

### Confirmation of Ejection Amount Based on Image

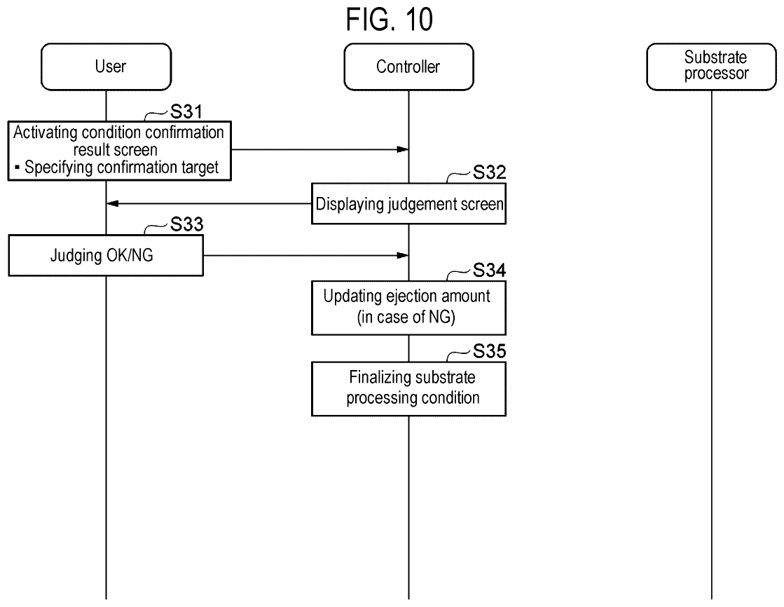

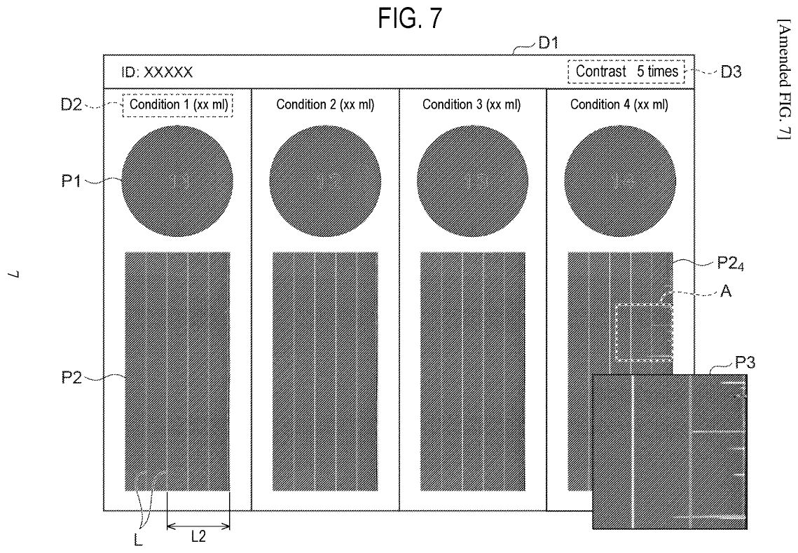

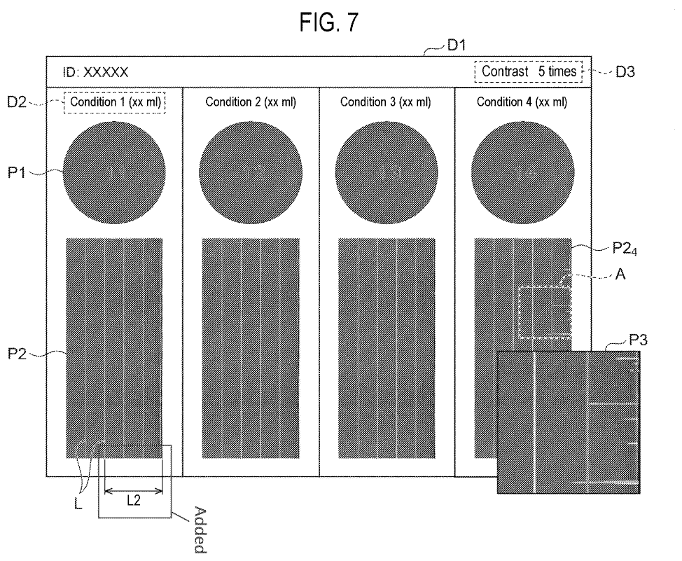

FIG. 10 is a diagram showing an example of a procedure in which the user determines the ejection amount of the resist liquid based on the image after processing, which is obtained by the procedure shown in FIG. 9. At this stage, the user checks, through the image, a state of the formation of the resist film formed on the front surface of each of the plurality of workpieces W produced by supplying the resist liquid at the same ejection amount under the same condition. While looking at these images, the user checks whether the resist film is uniformly formed (OK) or not (NG). At this stage, since it is determined whether a production condition of a confirmation sample may be used in the actual production, whether the resist film is properly formed on each of the plurality of workpieces W, rather than in units of workpieces W, is determined.

First, the user operates the input part 220 to activate a screen for displaying a condition confirmation result (a condition confirmation result screen) (step S31). In this case, the user specifies data to be confirmed by specifying a lot number or the like.

When the user instruction acquirer 102 acquires an instruction from the user, the controller 100 controls the screen outputter 101 such that the display part 210 displays a determination screen for confirming a result thereon (step S32). The determination screen displays an image of the workpiece W after processing, which corresponds to a resist liquid condition to be determined. A screen displayed at this stage may be the same as the display screens D1 and D4 shown in FIGS. 7 and 8. The determination screen may be configured to display images after processing and polar-coordinate-converted images with respect to the plurality of workpieces W. With this configuration, it is easy to check whether there is a less coated area (dry patch) on a peripheral portion of the workpiece W even at the stage of confirming the condition. In addition, when the contrast is set to be adjustable, non-uniformity of the formation of the resist film becomes easier to recognize.

The user determines whether the ejection amount condition used to produce the confirmation sample is appropriate (OK/NG determination) while referring to the image displayed on the display part 210 (step S33). The determination result is acquired by the user instruction acquirer 102. When the user determines that the ejection amount condition is NG, the substrate processing condition updater 107 updates the ejection amount condition of the resist liquid in the substrate processing condition (step S34). As an example, when the user determines that the ejection amount condition is NG, the ejection amount of the resist liquid is considered insufficient and the substrate processing condition updater 107 may increase the ejection amount of the resist liquid by a predetermined amount in the substrate processing condition for the actual production. In addition, when the ejection amount of the resist liquid is increased, the user may specify the increased amount. Further, the ejection amount may be finalized by repeating the procedures shown in FIGS. 9 and 10 based on the instruction of the user and producing again and evaluating the confirmation sample under a condition in which the ejection amount of the resist liquid is increased. When the user determines that the ejection amount of the resist liquid is OK, the substrate processing condition updater 107 may be configured not to change the ejection amount of the resist liquid in the substrate processing condition.

Through the above-mentioned procedure, the substrate processing condition for the actual production is finalized (step S35). The finalized substrate processing condition is retained in the substrate processing condition retainer 123 and may be used during the actual production.

### Action

According to the above liquid coating treatment method and liquid coating treatment device, one or more polar-coordinate-converted images P2 are displayed on a screen by creating polar-coordinate-converted images from surface images of a plurality of substrates (workpieces W) on which films are formed by a processing liquid of different ejection amounts. Therefore, the user may determine an ejection amount of the processing liquid ejected to the substrates while referring to the polar-coordinate-converted images P2 displayed on the screen. In this way, according to the above liquid coating treatment method and liquid coating treatment device, the user may determine the ejection amount of the processing liquid after checking a change in the films caused by the difference between the ejection amounts while looking at the polar-coordinate-converted images.

In addition, for example, as shown in FIG. 7, the surface images P1 of the substrates prior to polar coordinate conversion are displayed together with the images P2 after polar coordinate conversion. Thus, the user may determine the ejection amount of the processing liquid ejected to the substrates while checking actual states of the substrate surfaces in addition to the polar-coordinate-converted images P2. Since the images P1 of the substrate surfaces are images obtained by capturing the entire substrates, the user may check a situation of the entire substrates by looking down at these images.

In addition, as shown in FIGS. 7 and 8, the contrast of the images displayed on the screen may be adjusted. With this configuration, the user may check a subtle change in the substrate surfaces, for example, by emphasizing the contrast. In this way, the user may obtain much information from the images. Thus, the user may more appropriately determine the ejection amount.

Further, as shown in the polar-coordinate-converted images P2 in FIG. 7, the auxiliary line L indicating the distance from the peripheral edge or the center of the substrate may be additionally displayed with respect to the polar-coordinate-converted images. In this case, the user may easily recognize what changes are occurring at a position of a distance L2 from the peripheral edge of the substrate.

Further, by displaying information specifying the substrates from which the images are captured in association with the polar-coordinate-converted images P2, the user easily intuitively recognizes which substrate an image represents.

Further, two or more polar-coordinate-converted images of the plurality of polar-coordinate-converted images may be displayed on the screen in order of the ejection amounts of the processing liquid. In this case, the user may easily recognize changes in the surface states of the substrates caused by changes in the ejection amounts of the processing liquid.

As shown in FIG. 7, a specific area of the images may be enlarged based on the instruction of the user. In this case, the user may check in detail a portion that the user is interested in (for example, a portion at which non-uniformity occurs or a less coated portion). Thus, the user may more appropriately determine the ejection amount from such image information.

As in the procedure shown in FIG. 9, a plurality of confirmation images may be acquired by individually acquiring surface images of the plurality of substrates having, on surfaces thereof, films formed by supplying the processing liquid of the determined ejection amount to each of the plurality of substrates. As shown in FIG. 10, the acquired confirmation images may be displayed on the screen, and the ejection amount of the processing liquid in the substrate processing condition may be finalized. With this configuration, for example, whether the state of the substrate surface when an image is acquired to determine the ejection amount is accidental or normal may be confirmed. Therefore, the finalized substrate processing condition in finalizing the ejection amount is suitable for processing the plurality of substrates.

### Others

While various exemplary embodiments have been described above, various omissions, substitutions, and modifications may be made without being limited to the exemplary embodiments described above. In addition, elements of different embodiments may be combined to provide other embodiments.

For example, the screen display shown in FIGS. 7 and 8 are merely examples, and layout or design thereof may be appropriately modified. The information input by the user may also be appropriately modified. As an example of modifying the screen display, the polar-coordinate-converted image P2 shown in FIG. 7 may be displayed in a state in which the image P2 is returned to an image based on normal coordinates. As another modification example, there may be a modification focusing on a coating state (non-uniformity of color) of a peripheral portion of the workpiece W. For example, in a case in which the peripheral portion of the workpiece W is coated with the processing liquid (for example, resist liquid), when the coating state is not uniform, this will cause occurrence of a defective product. Therefore, the coating state (non-uniformity of color) of the processing liquid in the peripheral portion of the workpiece W shown in FIG. 8 may be represented by a numerical value or a graph. As another modification example, for example, an RGB value or a gray value of a specified portion (for example, a peripheral area of the workpiece W) on the screen of FIG. 7 or 8 may be represented as a graph.

The procedures shown in FIGS. 5 to 10 are merely examples, and the processing content and order of each step may be changed.

In the above procedures, while the processing liquid has been described as the resist liquid, the type of the processing liquid is not limited to the resist liquid.

From the foregoing description, it will be appreciated that various embodiments of the present disclosure have been set forth herein for purposes of illustration, and various changes may be made without departing from the scope and spirit of the present disclosure. Therefore, the various embodiments disclosed herein are not intended to be limitative. The true scope and spirit are defined by the appended claims.

### Supplementary Notes

Various exemplary embodiments included in the present disclosure are described as follows.

[1]

A coating treatment method includes individually acquiring surface images of a plurality of substrates, wherein different films are formed on surfaces of the plurality of substrates by supplying a processing liquid of different ejection amounts; obtaining a plurality of polar-coordinate-converted images by converting the surface images of the plurality of substrates to polar coordinates, respectively; displaying one or more polar-coordinate-converted images of the plurality of polar-coordinate-converted images on a screen in association with information specifying the different ejection amounts of the processing liquid ejected to the plurality of substrates from which the one or more polar-coordinate-converted images are captured; and determining the different ejection amounts of the processing liquid ejected to the plurality of substrates when forming the different films of the processing liquid based on an instruction of a user relating to a display content on the screen.

[2]

In the coating treatment method of [1] above, the displaying includes displaying the surface images of the plurality of substrates prior to the converting the surface images of the plurality of substrates to polar coordinates together with the polar-coordinate-converted images.

[3]

In the coating treatment method of [1] or [2] above, the displaying includes adjusting a contrast of the images displayed on the screen.

[4]

In the coating treatment method of any one of [1] to [3] above, the displaying includes additionally displaying an auxiliary line indicating a distance from a peripheral edge or a center of each of the plurality of substrates with respect to the polar-coordinate-converted images.

[5]

In the coating treatment method of any one of [1] to [4] above, the displaying includes displaying information specifying the plurality of substrates from which the one or more polar-coordinate-converted images are captured in association with the one or more polar-coordinate-converted images.

[6]

In the coating treatment method of any one of [1] to [5] above, the displaying includes displaying two or more polar-coordinate-converted images of the plurality of polar-coordinate-converted images on the screen in association with information specifying the different ejection amounts of the processing liquid ejected to the plurality of substrates from which the two or more polar-coordinate-converted are captured and in a state in which the different ejection amounts of the processing liquid are sequentially arranged.

[7]

In the coating treatment method of any one of [1] to [6] above, the displaying includes displaying a specific area of the one or more polar-coordinate-converted images in an enlarged form based on the instruction of the user.

[8]

The coating treatment method of any one of [1] to [7] above further includes: acquiring a plurality of confirmation images by individually acquiring the surface images of the plurality of substrates, wherein the different films are formed on the surfaces of the plurality of substrates formed by supplying the processing liquid of the different ejection amounts determined in the determining to each of the plurality of substrates; displaying the plurality of confirmation images on the screen; and finalizing the different ejection amounts of the processing liquid in a substrate processing condition based on the instruction of the user relating to the display content on the screen.

[9]

A non-transitory computer-readable storage medium storing a program for causing an apparatus to execute the coating treatment method of any one of [1] to [8] above.

[10]

A coating treatment device includes an image acquirer configured to individually acquire surface images of a plurality of substrates, wherein different films are formed on surfaces of the plurality of substrates by supplying a processing liquid of different ejection amounts; an image converter configured to obtain a plurality of polar-coordinate-converted images by converting the surface images of the plurality of substrates to polar coordinates, respectively; a display part configured to display one or more polar-coordinate-converted images of the plurality of polar-coordinate-converted images on a screen in association with information specifying the different ejection amounts of the processing liquid ejected to the plurality of substrates from which the one or more polar-coordinate-converted images are captured; and an ejection amount determiner configured to determine the different ejection amounts of the processing liquid ejected to the plurality of substrates when forming the different films of the processing liquid based on an instruction of a user relating to a display content on the screen.

### EXPLANATION OF REFERENCE NUMERALS

1: substrate processing system, 2: coating/developing apparatus, 92: surface inspector, 100: controller, 101: screen outputter, 102: user instruction acquirer, 103: image converter, 104: condition-determination sample production condition setter, 105: confirmation sample production condition setter, 106: processed-image acquirer, 107: substrate processing condition updater, 108: substrate processing controller, 110: user interface, 121: sample production condition retainer, 122: substrate image retainer, 123: substrate processing condition retainer

1. A coating treatment method, comprising:
individually acquiring surface images of a plurality of substrates, wherein different films are formed on surfaces of the plurality of substrates by supplying a processing liquid of different ejection amounts;
obtaining a plurality of polar-coordinate-converted images by converting the surface images of the plurality of substrates to polar coordinates, respectively;
displaying one or more polar-coordinate-converted images of the plurality of polar-coordinate-converted images on a screen in association with information specifying the different ejection amounts of the processing liquid ejected to the plurality of substrates from which the one or more polar-coordinate-converted images are captured; and
determining the different ejection amounts of the processing liquid ejected to the plurality of substrates when forming the different films of the processing liquid based on an instruction of a user relating to a display content on the screen.

2. The coating treatment method of claim 1, wherein the displaying includes displaying the surface images of the plurality of substrates prior to the converting the surface images of the plurality of substrates to polar coordinates together with the polar-coordinate-converted images.

3. The coating treatment method of claim 1, wherein the displaying includes adjusting a contrast of the images displayed on the screen.

4. The coating treatment method of claim 1, wherein the displaying includes additionally displaying an auxiliary line indicating a distance from a peripheral edge or a center of each of the plurality of substrates with respect to the polar-coordinate-converted images.

5. The coating treatment method of claim 1, wherein the displaying includes displaying information specifying the plurality of substrates from which the one or more polar-coordinate-converted images are captured in association with the one or more polar-coordinate-converted images.

6. The coating treatment method of claim 1, wherein the displaying includes displaying two or more polar-coordinate-converted images of the plurality of polar-coordinate-converted images on the screen in association with information specifying the different ejection amounts of the processing liquid ejected to the plurality of substrates from which the two or more polar-coordinate-converted are captured and in a state in which the different ejection amounts of the processing liquid are sequentially arranged.

7. The coating treatment method of claim 1, wherein the displaying includes displaying a specific area of the one or more polar-coordinate-converted images in an enlarged form based on the instruction of the user.

8. The coating treatment method of claim 1, further comprising:
acquiring a plurality of confirmation images by individually acquiring the surface images of the plurality of substrates, wherein the different films are formed on the surfaces of the plurality of substrates formed by supplying the processing liquid of the different ejection amounts determined in the determining to each of the plurality of substrates;
displaying the plurality of confirmation images on the screen; and
finalizing the different ejection amounts of the processing liquid in a substrate processing condition based on the instruction of the user relating to the display content on the screen.

9. A non-transitory computer-readable storage medium storing a program for causing an apparatus to execute the coating treatment method of claim 1.

10. A coating treatment device, comprising:
an image acquirer configured to individually acquire surface images of a plurality of substrates, wherein different films are formed on surfaces of the plurality of substrates by supplying a processing liquid of different ejection amounts;
an image converter configured to obtain a plurality of polar-coordinate-converted images by converting the surface images of the plurality of substrates to polar coordinates, respectively;
a display part configured to display one or more polar-coordinate-converted images of the plurality of polar-coordinate-converted images on a screen in association with information specifying the different ejection amounts of the processing liquid ejected to the plurality of substrates from which the one or more polar-coordinate-converted images are captured; and
an ejection amount determiner configured to determine the different ejection amounts of the processing liquid ejected to the plurality of substrates when forming the different films of the processing liquid based on an instruction of a user relating to a display content on the screen.
